(19) United States
(12) Patent Application Publication
(10) Pub. No.: US 2002/0113827 A1
(43) Pub. Date: Aug. 22, 2002

(54) Apparatus and method for selecting data

(76) Inventors: Stephen G. Perlman, Palo Alto, CA (US); Brian Lanier, Los Gatos, CA (US); Ain McKendrick, Menlo Park, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/791,474

(22) Filed: Feb. 22, 2001

(51) Int. Cl. G06F 3/00

(52) U.S. Cl. 345/840

(57) ABSTRACT

A method is disclosed comprising: selecting a first group of characters to be mapped to a group of remote control buttons based on how probable it is that individual characters within the first group correspond to a first character of a word representing information sought by a user in a database; and mapping the first group of characters to the group of remote control buttons.

### BACKGROUND

1. Field of the Invention

This invention relates generally to the field of data input techniques. More particularly, the invention relates to an apparatus and method for entering alphanumeric characters and selecting data using a remote control device.

2. Description of the Related Art

Current remote control devices allow users to enter alphanumeric characters to search for program content and other types of program-related information. For example, one type of device allows users to identify a program by scrolling through the alphabet (e.g., via scroll up/down buttons) and selecting the first few characters of the program title. Scrolling through alphanumeric characters in this manner, however, is somewhat inefficient, particularly if more than two or three characters are required to identify the program.

Other types of remote control devices provide printed letters on a numeric keypad for data entry (e.g., in a similar manner to a standard telephone keypad). However, this type of remote control can be problematic, particularly in a typical living room environment. For one thing, many users (e.g., those over 45) will need reading glasses to see such small letters. These users will not typically be wearing reading glasses, however, when watching a television program from across the room and, even when wearing reading glasses, these users will be forced to continuously take them off and put them on again when viewing the TV and looking at the remote control, respectively. Moreover, rooms may be dark, thereby further impairing viewing of the printed letters.

Accordingly, what is needed is a more efficient apparatus and method for entering characters using a remote control device. What is also needed is an apparatus and method which will allow users to enter characters without looking away from the television screen (or other type of display).

### SUMMARY OF THE INVENTION

A method is disclosed comprising: selecting a first group of characters to be mapped to a group of remote control buttons based on how probable it is that individual characters within the first group correspond to a first character of a word representing information sought by a user in a database; and mapping the first group of characters to the group of remote control buttons.

### BRIEF DESCRIPTION OF THE DRAWINGS

A better understanding of the present invention can be obtained from the following detailed description in conjunction with the following drawings, in which:

FIGS. 1a and 1b illustrate a remote control device according to one embodiment of the invention.

FIG. 2 illustrates a graphical user interface according to one embodiment of the invention.

FIGS. 3-6 illustrate data entry techniques according to embodiments of the invention.

FIGS. 7-8 illustrate an embodiment of the invention in which the same set of buttons are shared between numbers and characters.

### DETAILED DESCRIPTION

In the following description, for the purposes of explanation, numerous specific details are set forth in order to provide a thorough understanding of the present invention. It will be apparent, however, to one skilled in the art that the invention may be practiced without some of these specific details. In other instances, well-known structures and devices are shown in block diagram form to avoid obscuring the underlying principles of the invention.

### Embodiments of an Apparatus and Method for Selecting Data

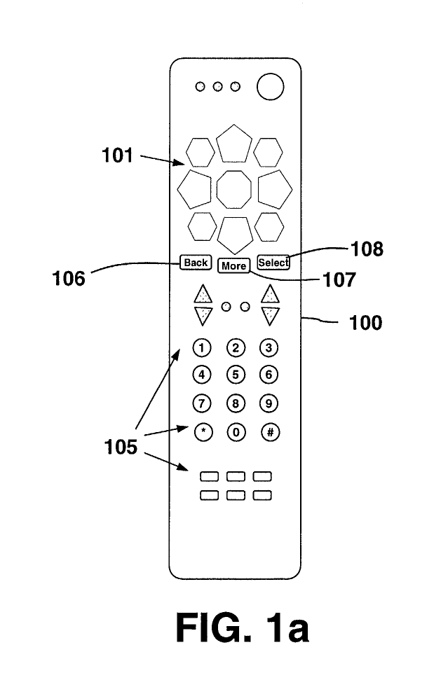

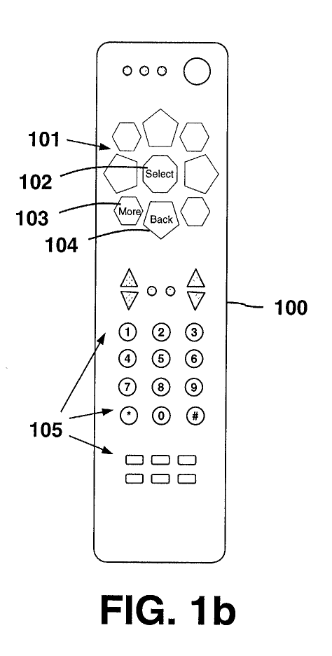

One embodiment of the invention allows user to rapidly enter alphanumeric characters (or other types of symbols) without looking away from the television/computer screen. More specifically, as illustrated in FIGS. 1a through 1c, a group of directional and functional buttons 101 arranged in a “star” pattern are configured on the remote control device 100, and a corresponding set of buttons 110 are displayed on the television/computer display 105. In the embodiment illustrated in FIG. 1a, all nine of the buttons 101 are character-mapped buttons, each having a different alphanumeric character mapped thereto. In addition, the remote control device 100 includes a “more” button 107 for mapping a new set of characters to the character-mapped buttons 101 (e.g., to locate a letter which is not currently displayed), a “select” button 108 for making various types of data selections, and a “back” button 106 for deleting an entered character and/or moving backwards through a menu structure (as described in greater detail below).

In the embodiment illustrated in FIG. 1b, the “select” function, the “more” function and the “back” function are mapped to the set of character-mapped buttons 101 (as indicated on buttons 102, 103, and 104, respectively). Accordingly, in this embodiment, only six buttons are available for mapped characters. The remote control device 100 may also include a set of “standard” buttons 105 for performing various known remote control functions (e.g., selecting channels, increasing/decreasing volume . . . etc).

Although illustrated above as a set of nine buttons arranged in a “star” configuration, it should be noted that the underlying principles of the invention are not limited to any particular number of buttons or any particular button arrangement. Moreover, a dedicated set of buttons 101 as illustrated in FIGS. 1a and 1b is not required for complying with the underlying principles of the invention. For example, in one embodiment of the invention, the standard set of buttons 104 (e.g., numeric buttons 0-9) may be configured/programmed to perform the data selection techniques described herein. For example, in this embodiment, the numbers 1 through 9 may be used as character-mapped buttons, the number button (#) may be configured as a “select” button, the asterisk button (*) may be configured as the “more” button, and the zero button may be used as the “back” button.

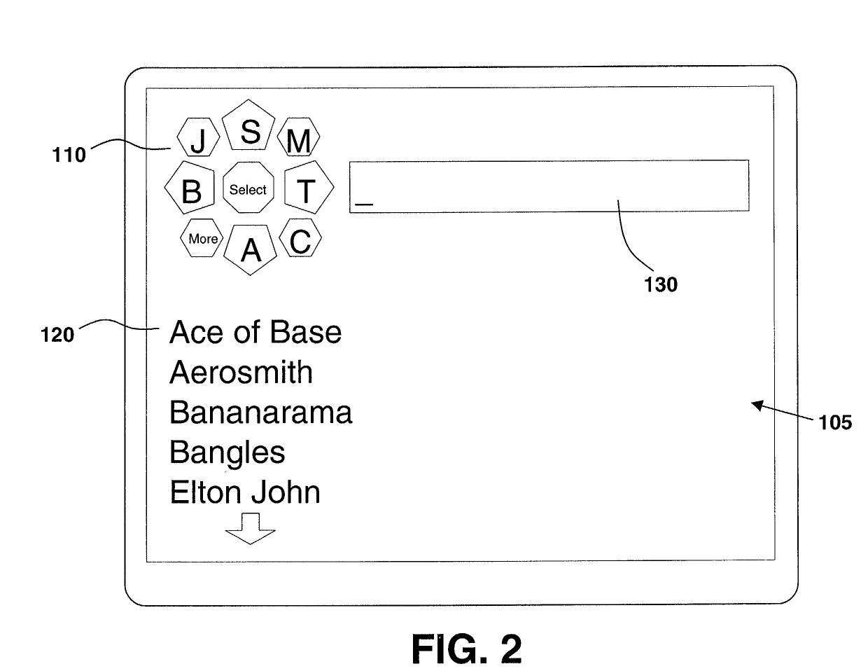

In the graphical user interface illustrated in FIG. 2, a database list 120 is displayed for the user on the television/computer display 105. In the illustrated embodiment, the database list is a list of available multimedia content. However, the underlying principles of the invention are not limited to any particular type of database. As the user selects letters via the displayed character-mapped buttons 110, the user's letter selections will appear in a text box 130, and the database list 120 will change to reflect the user's selections. Initially (i.e., before the user has selected a character), the alphanumeric characters mapped to the character-mapped buttons 101, 110 correspond to the most common first letters of words in the database list 120. Once the user selects a first character, a new set of characters are mapped to the character-mapped buttons 101, 110 which correspond to the most common second letters of words in the database list 120 which begin with the first-selected character. As the user continues to select characters, only those multimedia programs/files with titles which begin with the selected characters will be displayed in the list 120.

In addition, the “more, “select” and “back” functions may be mapped to the character-mapped buttons 101, 110 as illustrated in FIGS. 2 through 6 if/when those functions are available. However, if the remote control device illustrated in FIG. 1a is used, the “more,” “select” and “back” functions will not be mapped to the set of character-mapped buttons 101, 110 (i.e., because this embodiment uses dedicated buttons for these functions).

Factors other than the commonality of each of the characters may be considered when determining which characters to map to the character-mapped buttons 101, 110. For example, one embodiment of the invention will monitor and evaluate the user's preferences for each of the multimedia selections when making character-mapping determinations (i.e., if the database is a multimedia database). Accordingly, if a user plays back a particular multimedia program more frequently than any other program, the characters corresponding to that program may be displayed, notwithstanding the fact that they are relatively uncommon (i.e., relative to other characters in the database). Moreover, the user's multimedia preferences and the incidence of each of the characters may be weighted by different amounts when performing the character-mapping determination (e.g., 50% character incidence/50% user preferences; 75% character incidence/25% user preferences; . . . etc)

In one embodiment, once a set of characters are selected, they are mapped to the set of buttons from left to right in order of their appearance in the alphabet. For example, if the letters selected to be mapped based on incidence within the database are N, C, O, P, R, Z, T, B, and A, then these letters will be mapped from left to right in the following order: A, B, C, N, O, P, R, T, and Z. This will make it more obvious that the display is meant to be used for text input.

The operation of one particular embodiment of the invention will now be described with respect to the remaining figures. For the purpose of simplicity, character mapping for this embodiment will be based solely on the incidence of each of the characters within the database. However, as mentioned above, various other factors may be evaluated to select character-mappings while still complying with the underlying principles of the invention.

Referring again to FIG. 1b, if the user initially presses “select” (i.e., before selecting a single character), in one embodiment the group of displayed buttons 110 will disappear and the first entry in the list will be highlighted (e.g., the selection box may move down to the first entry). The user may then use up and down buttons (e.g., the center top and bottom character-mapped buttons or other dedicated up/down buttons) to navigate up and down the list, and select an entry by hitting the “select” button when the entry is highlighted.

Alternatively, the user may press a remote control button 101 with a mapped character as indicated on the graphical user interface (i.e., rather than initially choosing the “select” button 102). The selected character will then be typed/displayed in the text box 130, and the new character mappings will change to the most common second letters of entries that have the first letter that was typed. Once again, if the desired letter does not appear among the mapped letters, the user may press the “more” button 103 to retrieve a new group of the next most common letters.

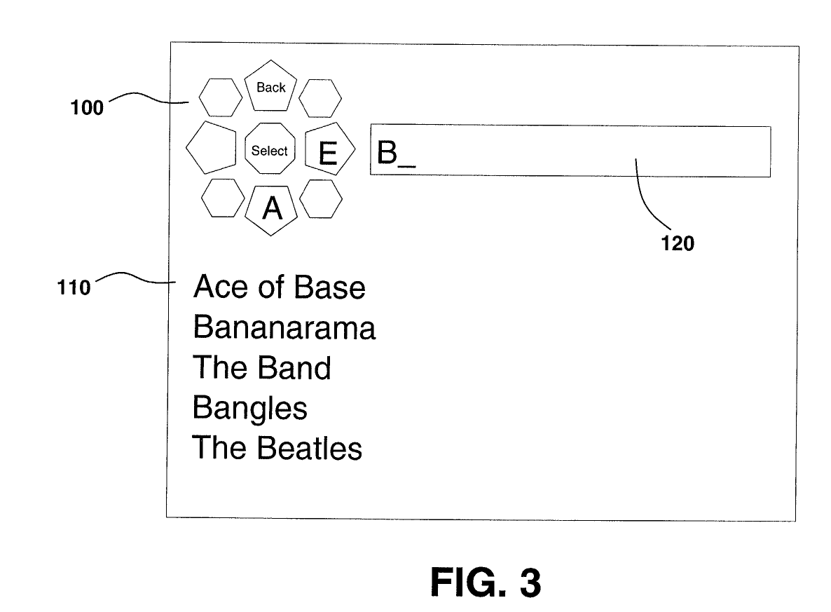

In one embodiment, any characters displayed in successive character mappings will be mapped to the same button. For example, the character “A,” displayed in the first set of mappings shown in FIG. 2, is mapped to the same button in the second character mapping illustrated in FIG. 3. Providing consistent mappings in this manner will make it easier for users to locate desired characters.

As mentioned above, the list of entries 120 will continuously change to reflect the user's character selections. For example, if “B” is typed, as illustrated in FIG. 3, a “B” will appear in the text box and only those entries having “B” as a first character will be listed. Note that, in the illustrated embodiment, only “A” and “E” are mapped to the character-mapped buttons 110 on the display 105 because these are the only possible second letters of words in the list which begin with “B.” If the user presses “select” at this stage, the first entry in the list (“Ace of Base”) will be highlighted, the star will disappear, and the user may use the up/down buttons to navigate through the remaining entries in the list.

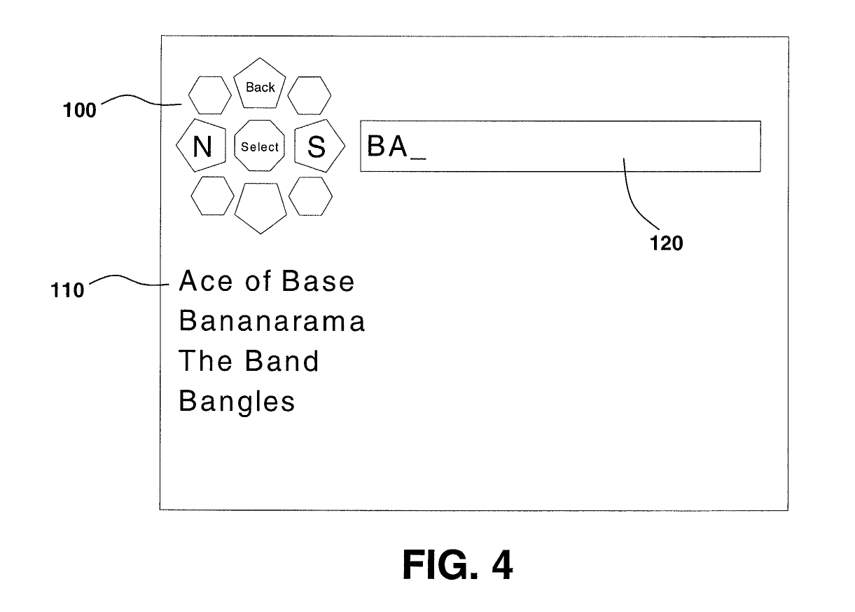

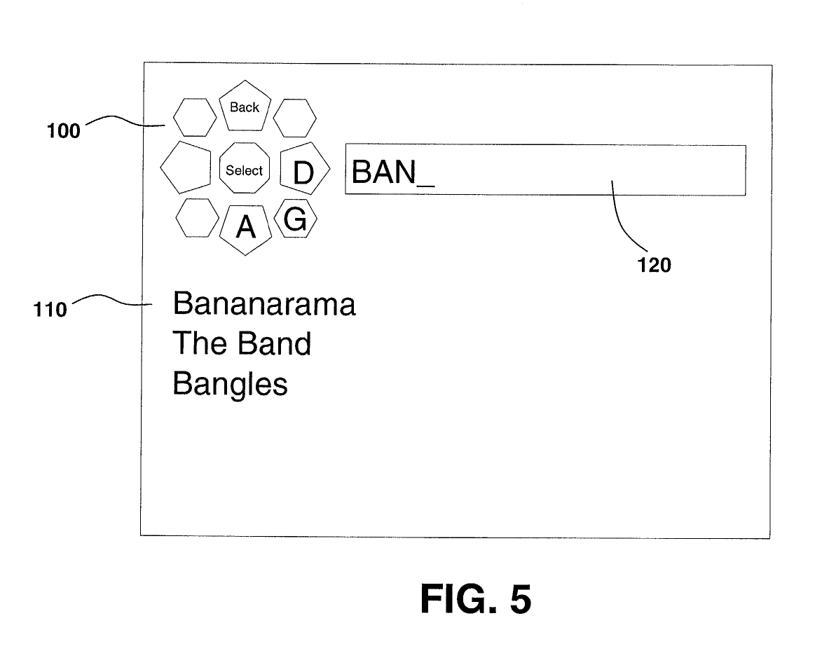

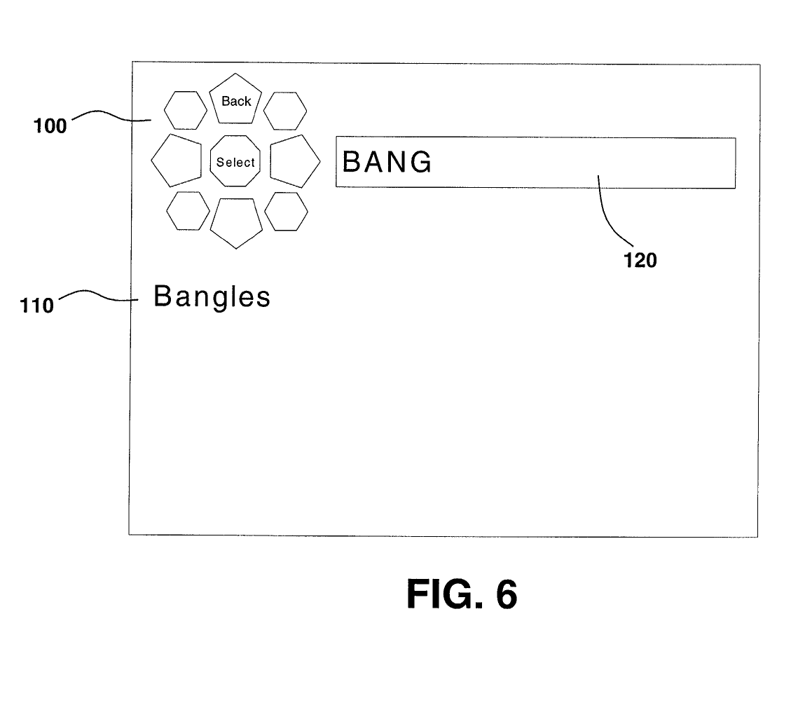

If, instead, the user selects another letter, then that letter will appear next to “B” and the list will be modified accordingly. For example, if the user selects “A,” then the list will change as indicated in FIG. 4. Moreover, the only possible third characters, “N” and “S,” will be mapped to the character-mapped buttons 110. If the user chooses “N” followed by “G” the list and the group of character-mapped buttons will be modified as indicated in FIGS. 5 and 6, respectively. Once “BANG” has been typed out, only one possible entry remains (“Bangles”), so the user is only provided with this entry to select via the select button 102.

If the user ever makes a mistake or decides to search for a different entry, he/she can use the “back” button to move backwards through his/her character selections. In the foregoing example, pressing the “back” button four times in succession when “BANG” is displayed will bring the system to the state shown in FIG. 1b (i.e., no characters selected). In addition, in one embodiment an “escape” button (not shown) may also be provided which, when selected, causes the system to exit the content/character selection mode described herein (i.e., so that the user does not get trapped in the selection mode).

Whether or not one of the buttons from the character-mapped group 101, 110 is used for the “back,” “escape,” “select,” and/or “more” functions may depend on how many character-mapped buttons 101, 110 are available. It may be preferable to provide these functions using one or more of the dedicated remote control buttons 104, so that the “star” buttons may be reserved for characters. For example, reserving 7 keys for letters (numbers may be entered using the standard remote buttons 103), all 26 letters may be selected with just 3 presses of “More” (7+(7*3)=26+2). However, with only 6 keys reserved for letters, it will take 4 presses of “More” (6+(6*4)=26+4). Thus, the speed with which a user may locate the correct characters may depend on the number of dedicated character-mapped buttons. However, as mentioned above, the underlying principles of the invention may be implemented using any number/configuration of the character-mapped buttons.

In one embodiment, instead of labeling the “star” button group 110 with letters, an entire group of letters may be shown when the grouping of letters is probable. Thus, in the above example, after the “B” is pressed, “AN” may be displayed. Similarly, if the user is attempting to select “JOHN,” “OHN” may be mapped to one of the buttons after the user selects “J” if a significant number of entries (i.e., musicians) in the database are named John.

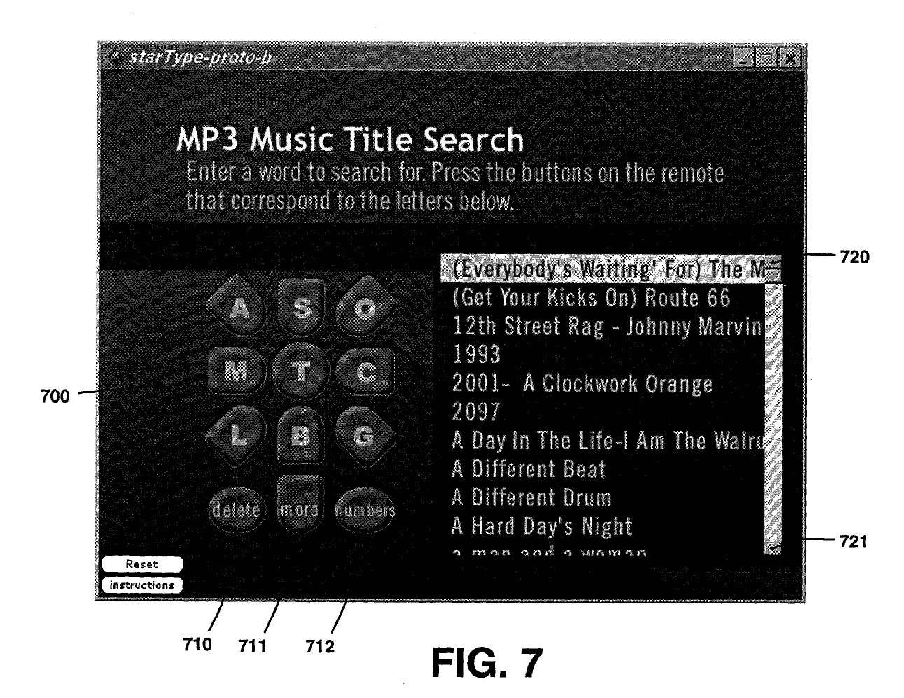

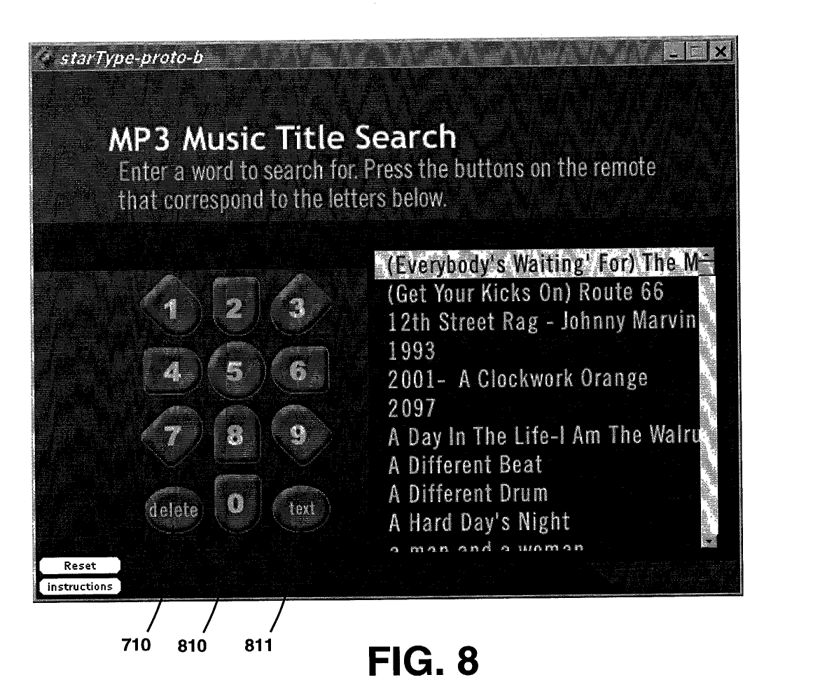

One embodiment of the invention in which the same set of remote control buttons are shared for both character entry and number entry is illustrated in FIGS. 7 and 8. The set of nine characters 700 (FIG. 7) are mapped to a corresponding set of nine remote control buttons on a remote control device as described above. In addition, “delete,” “more” and “numbers” functions 710, 711, and 712, respectively, are mapped to a set of three remote control buttons. The “delete” and “more” functions are described in detail above (as the “back” and “more” functions, respectively.

If the user needs to enter numbers rather than characters, he/she may select the “numbers” button. This will cause the graphical user interface to change to in a manner similar to that illustrated in FIG. 8. In particular, the nine character-mapped buttons 701 become buttons for entering numbers 1-9, as indicated; the “more” button becomes the ‘0’ button; the “delete” button remains the same; and the “numbers” button becomes the “text” button, for returning to the character-mapped functionality illustrated in FIG. 7 (i.e., the “more” button is not required when entering numbers because ten buttons are available for entering 0-9). As mentioned above, this embodiment may be employed using the standard set of numbers on a remote control device (i.e., along with the number (#) button and the asterisk (*) button).

In one embodiment, a remote control device will not be required at all. For example, if a touch-screen is used for data entry, the user will be able to select characters directly from the computer/television display (or other display type) and/or scroll down the list of data using directional keys (e.g., 720-721 in FIG. 7). This embodiment may be particularly suitable for use in an automobile (e.g., in an in-dashboard computer system) or other environment in which a remote control is not generally available.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout this detailed description, for the purposes of explanation, numerous specific details were set forth in order to provide a thorough understanding of the present invention. It will be apparent, however, to one skilled in the art that the system and method may be practiced without some of these specific details. For example, while the embodiments described above employ a dedicated set of character-mapped buttons, the underlying principles of the invention may be implemented using various other button configurations. For example, one or more of the standard remote control buttons 104 may be used to perform the character mapping techniques described herein. In other instances, well known structures and functions were not described in elaborate detail in order to avoid obscuring the subject matter of the present invention. Accordingly, the scope and spirit of the invention should be judged in terms of the claims which follow.

What is claimed is:

1. A method comprising:
selecting a first group of characters to be mapped to a group of remote control buttons based the probability that individual characters within said first group correspond to a first character of a word representing information sought by a user in a database; and
mapping said first group of characters to said group of remote control buttons.

2. The method as in claim 1 further comprising:
registering a selection of one of said first group of characters by said user; and
selecting a second group of characters to be mapped to said group of remote control buttons based on how probable it is that individual characters within said second group correspond to a second character of a word representing information sought by said user in said database; and
mapping said second group of characters to said group of remote control buttons.

3. The method as in claim 2 further comprising:
displaying a list of words for said user, each identifying different information in said database, said list of words having a first character as selected by said user.

4. The method as in claim 2 further comprising:
registering a selection of one of said second group of characters by said user; and
selecting a third group of characters to be mapped to said group of remote control buttons based on how probable it is that individual characters within said third group correspond to a third character of a word representing information sought by said user in said database; and
mapping said third group of characters to said group of remote control buttons.

5. The method as in claim 3 further comprising:
displaying a list of words for said user, each identifying different information in said database, said list of words having a first and second character as selected by said user.

6. The method as in claim 5 further comprising:
selecting said information responsive to said user selecting one of said list of words representing said information.

7. A system for identifying content within a database comprising:
a remote control device having a group of buttons for selecting characters;
mapping logic for mapping a first group of characters to said group of buttons, said first group of characters corresponding to first characters of titles of content in a database; and
display logic causing said mapping of said characters to said group of buttons to be displayed for a user.

8. The system as in claim 7 wherein said display logic causes a group of buttons to be displayed having a spatial configuration related to that of said group of buttons on said remote control device.

9. The system as in claim 8 wherein said spatial configuration is a star pattern.

10. The system as in claim 9 wherein said star pattern is comprised of nine buttons, with a center button and eight buttons forming a periphery.

11. The system as in claim 7 wherein said mapping logic is further configured to map a second group of characters to said group of buttons responsive to a user selecting one of said first group of buttons corresponding to one of said first group of characters,
said second group of characters corresponding to second characters of titles of content in said database, and wherein
said display logic is further configured to cause said mapping of said second group of characters to said group of buttons to be displayed for a user.

12. The system as in claim 7 wherein said mapping logic maps only one character per button.

13. The system as in claim 11 wherein said display logic is further configured to display a list of all content having titles starting with said one of said first group of characters.

14. The system as in claim 13 wherein said display logic is further configured to display a list of all content having titles starting with said one of said first group of characters as a first letter, and one of said second group of characters as a second letter, responsive to said user selecting said one of said second group of characters.

15. The system as in claim 14 further comprising:
selection logic for selecting specific content from said list responsive to a user request to select said content.

16. The system as in claim 15 wherein said user request is generated via a remote control device having a select button.

17. The system as in claim 7 wherein said first characters of titles of content in said database are more numerous than said first group of buttons, and wherein said mapping logic is further configured to select a subset of characters to be mapped from said first group of characters based on how probable it is that each of said characters will be selected by a user to identify specific content in said database.

18. The system as in claim 17 wherein how probable it is that said characters will be selected by said user is based on how frequently each of said characters appears as a first letter of a title in said database.

19. The system as in claim 17 wherein how probable it is that said characters will be selected by said user is based on how frequently said user requests content having first letters equivalent to each of said characters.

20. A system comprising:
character mapping means for selecting a set of characters to be mapped to a smaller set of buttons on a remote control device,
said characters selected to be mapped to said set of buttons based on how likely it is that each of said characters corresponds with first characters of titles in a content database.

21. The system as in claim 20 further comprising:
display means for causing said set of selected characters to be displayed as mapped to said set of buttons on said remote control device.

22. The system as in claim 21 wherein said display means further causes said set of characters to be overlayed on a set of displayed buttons spatially corresponding to said set of buttons on said remote control device.

23. The system as in claim 20 wherein said character mapping means is further configured to select a second set of characters to be mapped to said set of buttons on said remote control device responsive to a user selecting one of said first set of characters,
said second set of characters selected to be mapped to said set of buttons based on how likely it is that each of said second set of characters corresponds with second characters of titles in a content database.

24. The system as in claim 23 further comprising content display means for displaying a list of content having titles with first and second characters equivalent to said first and second characters selected by a user.

25. The system as in claim 24 further comprising:
selection means allowing a user to select content from said list of content.

26. An article of manufacture including code which, when executed by a machine, cause the machine to perform the operations of:
selecting a first group of characters to be mapped to a group of remote control buttons based the probability that individual characters within said first group correspond to a first character of a word representing information sought by a user in a database; and
mapping said first group of characters to said group of remote control buttons.

27. The article of manufacture as in claim 26 including code to cause said machine to perform the additional operations of:
registering a selection of one of said first group of characters by said user; and
selecting a second group of characters to be mapped to said group of remote control buttons based on how probable it is that individual characters within said second group correspond to a second character of a word representing information sought by said user in said database; and
mapping said second group of characters to said group of remote control buttons.

28. The article of manufacture as in claim 27 including code to cause said machine to perform the additional operations of:
displaying a list of words for said user, each identifying different information in said database, said list of words having a first character as selected by said user.

29. The article of manufacture as in claim 27 including code to cause said machine to perform the additional operations of:
registering a selection of one of said second group of characters by said user; and
selecting a third group of characters to be mapped to said group of remote control buttons based on how probable it is that individual characters within said third group correspond to a third character of a word representing information sought by said user in said database; and
mapping said third group, of characters to said group of remote control buttons.

30. The article of manufacture as in claim 29 including code to cause said machine to perform the additional operations of:
displaying a list of words for said user, each identifying different information in said database, said list of words having a first and second character as selected by said user.

31. The article of manufacture as in claim 30 including code to cause said machine to perform the additional operations of:
selecting said information responsive to said user selecting one of said list of words representing said information.

32. The article of manufacture as in claim 27 including code to cause said machine to perform the additional operations of:
mapping any characters included in both said first group of characters and said second group of characters to a same one of said remote control buttons.
